(19) United States
(12) Patent Application Publication
(10) Pub. No.: US 2011/0010496 A1
(43) Pub. Date: Jan. 13, 2011

(54) METHOD FOR MANAGEMENT OF DATA OBJECTS

(76) Inventors: Daniel KIRSTENPFAD, Erfurt (DE); Achim Friedland, Erfurt (DE)

Correspondence Address: Muncy, Geissler, Olds & Lowe, PLLC, 4000 Legato Road, Suite 310, FAIRFAX, VA, 22033, US

(21) Appl. No.: 12/557,301

(22) Filed: Sep. 10, 2009

(30) Foreign Application Priority Data
Jul. 7, 2009 (DE) DE 102009031923.9

(51) Int. Cl. G06F 12/00; G06F 12/02

(52) U.S. Cl. 711/114; 711/E12.001; 711/E12.008

(57) ABSTRACT

A method and system for management of data objects on a variety of storage media, wherein a storage control module is allocated to each of the storage media, wherein a file system is provided that communicates with each of the storage control modules, wherein the storage control module obtains information about the storage medium, the information including, at a minimum, a latency, a bandwidth, the number of possible parallel read/write accesses, or information on occupied and free storage blocks on the storage medium, wherein all information about the allocated storage medium is forwarded to the file system by the storage control module.

This nonprovisional application claims priority under 35 U.S.C. §119(a) to German Patent Application No. 10 2009 031 923.9, which was filed in Germany on Jul. 7, 2009, and which is herein incorporated by reference.

### BACKGROUND OF THE INVENTION

1. Field of the Invention

The invention relates to a method and system for management of data objects on a variety of storage media.

2. Description of the Background Art

One goal of data management is secure and powerful, which is to say rapid, storage of data objects on data media. Data objects can be documents, data records in a database, structured or unstructured data. Previous technical solutions for secure, high-performance storage and versioning of data objects divided the problem into multiple component problems independent from one another.

It is known, in a conventional system, to associate a file system FS with a storage medium M (FIG. 1). In this case, the file system FS describes a format and a management information for storage of data objects on a single storage medium M. If multiple storage media M are present in a computing unit, then each has an individual instance of such a file system FS. The storage medium M may be divided into partitions P, each of which is assigned its own file system FS. The type of partitioning of the storage medium M is stored in a partition table PT on the storage medium M.

To increase access speed and protection of data (redundancy) from technical failures such as, e.g., the failure of a storage medium M, it is possible to set up RAID systems (redundant array of inexpensive disks) (FIG. 2). In these systems, multiple storage media M1, M2 are combined into a virtual storage medium VM1. In more modern variants of this RAID system (FIG. 3), the individual storage media M1, M2 are combined into storage pools SP, from which virtual RAID systems with different configurations can be derived. In all variants considered, there is a strict separation between the storage and management of data records in data objects and directories and a block-based management of RAID systems.

In this context, a block is the smallest unit in which data objects are organized on the storage medium M1, M2; for example, a block can consist of 512 bytes. The storage space a file requires on the storage medium M does not exactly match its data quantity, e.g., 10000 bytes, but instead corresponds to at least the next larger multiple of the block size (20 blocks×512 bytes=10240 bytes).

Another problem in the management of data objects is versioning or version control. The goal here is to record changes to the data objects so that it is always possible to trace what was changed when by which user. Similarly, older versions of the data objects must be archived and reconstructed as needed. Such versioning is frequently accomplished by means of so-called snapshots. In this process, a consistent state of the storage medium M at the time of the snapshot creation is saved in order to protect against both technical and human failures. The goal is for subsequent write operations to write only the data blocks of the data objects that have changed from the preceding snapshot. The changed blocks are not overwritten, however, but instead are moved to a new position on the storage medium M, so that all versions are available with the smallest possible memory requirement. Accordingly, the versioning takes place purely at the block level.

Protection from disasters, for example the failure of storage media, can be achieved through the use of external backup software that implements complete replication of the data objects on independent storage media M. In this case, the user can neither control the backup nor access the saved data objects without the help of a cognizant administrator.

The management and maintenance of RAID and backup-based storage solutions require a considerable amount of technical and staff resources on account of the complex architecture of these systems. Nevertheless, at run time neither the users nor the administrators of such storage solutions can directly influence the backup measures for the stored data objects. Thus, for example, as a general rule neither the level of redundancy (the RAID level) of the overall storage solution nor that of individual data objects or older versions of these data objects can be changed without reinitializing the storage or file system and restoring a backup. Similarly, enlarging or reducing the storage capacity is only possible in isolated cases and in very special circumstances. FIG. 4 shows a RAID system with four storage media M1 to M4, each of which has a size of 1 Tbyte. On account of the redundancy, a total of 3 Tbytes of this is available for data objects. If one of the storage media M1 to M4 is replaced by a larger storage medium M1 to M4 with twice the size, 2 Tbyte, a time-consuming resynchronization procedure is then necessary in order to reestablish the redundancy before the RAID system can be operated in the usual manner again. The storage space available for data objects remains unchanged until all four storage media M1 to M4 have been replaced one by one. Only then is 6 Tbytes out of the new total of 8 Tbytes available for the storage of data objects. The resynchronization is necessary after each replacement.

These restrictions result from the fact that the granularity (the fineness of distinction) of these backup measures can only be tied to physical or logical storage media or file systems. Because of the previous architecture of these storage systems, a finer distinction among the requirements of individual data objects or revisions of data objects is impossible, or in isolated cases is simulated by a large number of subsidiary virtual storage or file systems.

Conventional storage systems are always based on a layered model in the architecture of the storage medium in order to be able to distinguish between different operating states in different layers in a defined manner.

The lowest layer of such a layered model is the storage medium M, for example. This is characterized, for example, by the following features and functions:

Media type (tape drive, hard disk, flash memory, etc.)

Access method (parallel or sequential)

Status and information of self-diagnostics

Management of faulty blocks

Located as the next layer above this lowest layer, for example, is the RAID system, which may be implemented as RAID software or as a RAID controller. The following features and functions are allocated to this RAID layer:

Partitioning of storage media

Allocation of storage media to RAID groups (active, failed, reserved)

Access rights (read only/read and write)

Located above the RAID layer is, for example, a file system layer (FS) with the following features and functions:

Allocation of data objects to blocks

Management of rights and metadata

Each of the layers communicates only with the adjacent layers located immediately above and below it. This layer model has the result that the individual layers, each building on the other, do not have the same information. This circumstance is intended in the prior art for the purposes of reducing the complexity of the individual systems, standardization and increasing the compatibility of components from different manufacturers. Each layer depends on the layer below it. Accordingly, in the event of a failure of one of the storage media M1 to M4, the file system FS does not know which storage medium M1 to M4 of the RAID group has just failed and cannot inform the user of the potential absence of redundancy. On the other hand, after the failed storage medium M1 to M4 has been replaced with a functioning one, the RAID system must undertake a complete resynchronization of the RAID group, despite the fact that only a few percent of the data objects are affected in most cases, and this information is present in the file system FS.

Modern storage systems attempt to ensure a consistent state of the management data structures of the storage system with the aid of journals. Here, all changes to the management data for a file are stored in a reserved storage area, the journal, prior to the actual writing of all of the changes. The actual user data are not captured, or are only inadequately captured, by this journal, so that data loss can nonetheless occur.

### SUMMARY OF THE INVENTION

It is therefore an object of the present invention to provide an improved method for management of data objects.

In an embodiment for management of data objects on at least one storage medium, in particular on a variety of storage media, a storage control module can be allocated to each of the storage media. A file system communicates with each of the storage control modules, wherein the storage control module obtains information about the storage medium, said information including, at a minimum, a latency, a bandwidth, and information on occupied and free storage blocks on the storage medium. All information about the allocated storage medium is forwarded to the file system by the storage control module. This means that, unlike in a layer model, the information is not limited to communication between adjacent layers, but instead is also available to the file system and, if applicable, to layers above it. Because of this simplified layer model, at least the file system has all information about the entire storage system, all storage media, and all stored data objects at all times. As a result, it is possible to carry out optimization and react to error conditions in an especially advantageous manner. Management of the storage system is simplified for the user. For example, during replacement of a storage medium that forms a redundant system (RAID) together with multiple other storage media, significantly faster resynchronization can take pace, since the file system has the information about occupied and free blocks, and hence only the occupied and affected blocks need be synchronized. The RAID system in question is operational again potentially within minutes, in contrast to conventional systems, for which a resynchronization may take several hours. In addition, when a storage medium is replaced by one with larger capacity, the additional capacity is made available in a simpler manner.

Information about each of the data objects can be maintained in the file system, including at least its identifier, its position in a directory tree, and metadata containing at least an allocation of the data object, which is to say its storage location on at least one of the storage media.

In an embodiment of the method, the allocation of each of the data objects can be selected by the file system based on the information about the storage medium and based on predefined requirements for latency, bandwidth and frequency of access for this data object. This means, for example, that a data object that is needed very rarely or with low priority can be stored on a tape drive, for example, while a data object that is needed more frequently is stored on a hard disk, and an object that is needed very frequently may be stored on a RAM disk, a part of working memory that is generally volatile but in exchange is especially fast.

Further, a redundancy of each of the data objects can be selected by the file system on the basis of a predefined minimum requirement for redundancy. This means that the entire storage system need not be organized as a RAID system with a single RAID level (redundancy level). Instead, each data object can be stored with its individual redundancy. The metadata concerning what redundancy level was selected for a particular data object is stored directly with the data object as part of the management data.

As additional information about the storage medium, a measure of speed can be determined, which reflects how rapidly previous accesses have taken place and the degree to which different storage media can be used simultaneously and independently of one another. In addition, the number of parallel accesses that can be used with a storage medium can be determined. Taking this information into account in the allocation of the data object reflects reality even better than merely the latency and bandwidth determined by the storage control module. For example, the storage control module can access a remote storage medium over a network. In this context, the availability of the storage medium is also a function of the utilization of capacity and topology of the networks, which are thus taken into account.

The allocation of the data objects can be extent-based. An extent can be a contiguous storage area encompassing several blocks. When a data object is written, at least one such extent is allocated. In contrast to block-based allocation, large data objects can be stored more efficiently, since in the ideal case one extent fully reflects the storage area of a data object, and it is thus possible to save on management information.

Preferably, the copy-on-write semantic is used. This means that write operations always take place only on copies of the actual data, and thus a copy of existing data is made before it is changed. This method ensures that at least one consistent copy of the object is present even in the case of a disaster. The copy-on-write semantic protects the management data structure of the storage system in addition to the data objects. Another possible use of the copy-on-write semantic is snapshots for versioning of the storage system.

As already described, it is possible to use as a storage medium a hard disk, a portion of a working memory, a tape drive, a remote storage medium on a network, or any other storage medium. In this regard, the information about the storage medium that is passed on is, at minimum, whether the storage medium is volatile or nonvolatile. While a working memory is suitable for storage of frequently used data objects on account of its short access times and high bandwidth, its volatility means that it provides no data protection in a power outage.

During a read operation on the storage medium, an amount of data larger than that requested can be sequentially read in and buffered in a volatile memory (cache). This method is called read-ahead caching. Similarly, during intended write operations on the storage medium, data objects from multiple write operations can be initially buffered in a volatile memory and can then be sequentially written to the storage medium. This method is called write-back caching. Read-ahead caching and write-back caching are caching methods that have the goal of increasing read and write performance. The read-ahead method exploits the property—primarily of hard disks—that sequential read accesses can be completed significantly faster than random read accesses over the entire area of the hard disk. For random read operations, the read-ahead cache mechanism strives to keep the number of such accesses as small as possible in that under some circumstances, somewhat more data objects than the single random read operation would require in and of itself are read from the hard disk—but are read sequentially, and thus faster. A hard disk is organized such that, as a result of its design, only complete internal disk blocks (which are different from the blocks of the storage system) are read. In other words, even if only 10 bytes are to be read from a hard disk, a complete block with a significantly larger amount of data (e.g., 512 bytes) is read from the hard disk. In this process, the read-ahead cache can store up to 512 bytes in the cache without any additional mechanical effort, so to speak. Write-back caching takes a similar approach with regard to reducing mechanical operations. It is most practical to write data objects sequentially. The write-back cache makes it possible, for a certain period of time, to collect data objects for writing and potentially combine them into larger sequential write operations. This makes possible a small number of sequential write operations instead of many individual random write operations.

A strategy for the read or write operation, in particular the aforementioned read-ahead and write-back caching strategy, can be selected on the basis of the information about the storage medium. This is referred to as adaptive read-ahead and write-back caching. The method is adaptive because the storage system strives to deal with the specific characteristics of the physical storage media. Non-mechanical flash memory requires a different read/write caching strategy than mechanical hard disk storage.

In order to ensure the integrity of the data object, a data stream which contains the data object can be protected by a checksum. A data stream can comprise one or more extents, each of which in turn comprises one or more contiguous blocks on the storage medium.

In addition, the data stream can be subdivided into checksum blocks, each of which can be protected by an additional checksum. Checksum blocks are blocks of predetermined maximum size for the purpose of generating checksums over sub-regions of the data stream.

Provision can be made to compress data objects for writing and decompress them after reading in order to save storage space. The compression/decompression can take place transparently. This means that it makes no difference to a user application whether the data objects that are read were stored on the storage medium compressed or uncompressed. The compression and management work is handled entirely by the storage system. The complexity of data storage increases from the point of view of the storage system in this method.

In an embodiment of the invention, multiple data objects and/or paths can be organized and placed in relation to one another (linked) in the manner of a graph. Such a graph-like linking is implemented by the means that an object location, which is to say a position of a data object in a path, has allocated to it an alias and, through the linking, another object location. Such linkages can be created and managed in a database placed upon the file system as an application.

An interface can be provided for user applications, by means of which functionalities related to the data object can be extended. This case is also referred to as extendible object data types. For example, a functionality can be provided that makes available full-text search on the basis of a stored object. Such a plug-in could extract a full text, process it, and make it available for searching by means of a search index.

The metadata can be made available at the interface by the user application. Such a plug-in-based access to object metadata achieves the result that plug-ins can also access the management metadata, or management data structure, of the storage system in order to facilitate expanded analyses. One possible scenario is an information lifecycle management plug-in that can decide, based on the access patterns of individual objects, on which storage medium and in what manner an object is stored. For example, in this context the plug-in should be able to influence attributes such as compression, redundancy, storage location, RAID level, etc.

The user interface can be provided for a compression and/or encryption application selected and/or implemented by the user. This ensures a trust relationship on the part of the user with regard to the encryption. This complete algorithmic openness permits gapless verifiability of encryption and offers additional data protection.

In another embodiment, a virtual or recursive file system can be provided, in which multiple file systems are incorporated. The task of the virtual file system is to combine multiple file systems into an overall file system and to achieve an appropriate mapping. For example, when a file system has been incorporated into the storage system under the alias “/FS2,” the task of the virtual file system is to correctly resolve this alias during use and to direct an operation on “/FS2/directory/data object” to the subpath ‘/directory/data object’ on the file system under “/FS2.” In order to simplify the management of the virtual file system, there is the option of recursively incorporating file systems into other virtual file systems.

Information such as the system metadata creation time, last access time, modification time, deletion time, object type, version, revision, copy, access rights, encryption information, and membership in object data streams can be associated with the data object.

At least one of the attributes of integrity, encryption, and allocated extents can be associated with the object data stream.

During replacement of one of the storage media, a resynchronization is performed in which the storage location and the redundancy for each data object can be determined anew on the basis of the minimum requirements predefined for the data object.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a layer model of a simple storage system according to the conventional art;

FIG. 2 shows a layer model of a RAID storage system according to the conventional art;

FIG. 3 shows a layer model of a RAID storage system with a storage pool according to the conventional art;

FIG. 4 shows a schematic representation of a resynchronization process on a RAID storage system according to the conventional art;

FIG. 5 shows a schematic representation of a storage system;

FIG. 6 shows a schematic representation of the use of checksums on data streams and extents;

FIG. 7 shows a schematic representation of an object data stream and the use of checksums;

FIG. 8 shows a representation of a read access in the storage system;

FIG. 9 shows a representation of a write access in the storage system;

FIG. 10 shows a schematic representation of a resynchronization process on the storage system; and

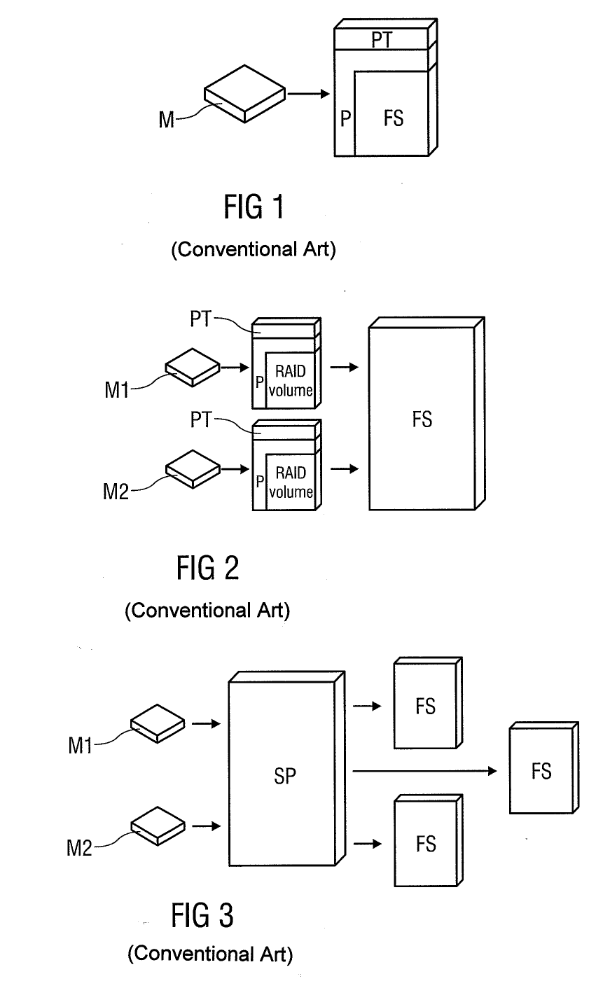

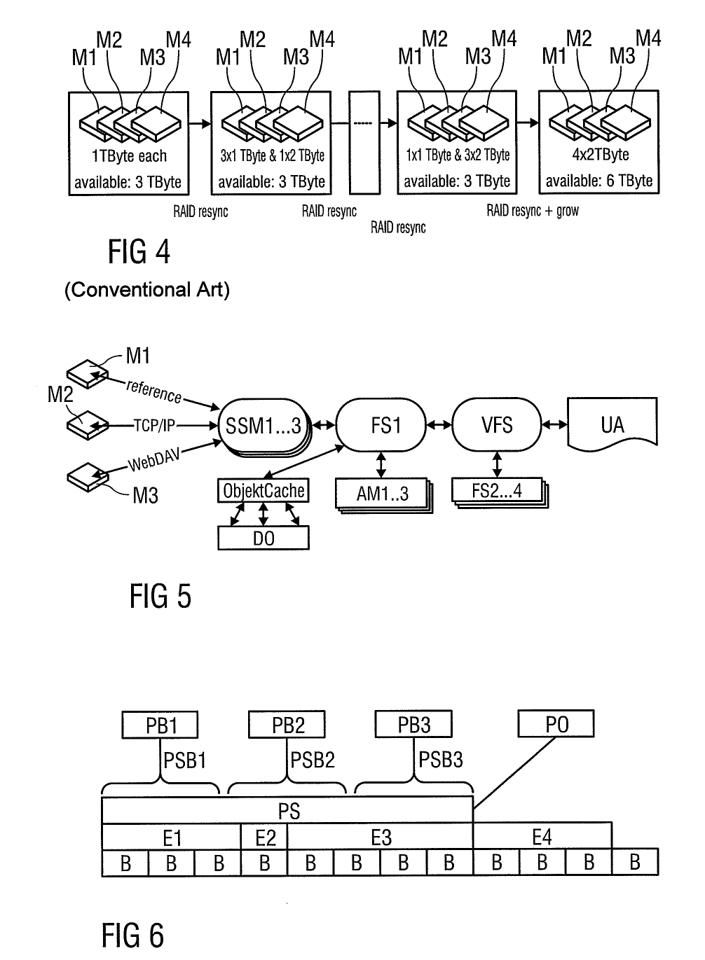

### DETAILED DESCRIPTION

FIG. 5 shows a schematic representation of a storage system. It is comprised of a number of storage media M1 to M3, wherein a storage control module SSM1 to SSM3 is allocated to each of the storage media M1 to M3. The storage control modules SSM1 to SSM3 are also referred to as storage engines and may be designed either in the form of a hardware component or as a software module. A file system FS1 communicates with each of the connected storage control modules SSM1 to SSM3. Information about the particular storage medium M1 to M3 is obtained by the storage control module SSM1 to SSM3, including, at a minimum, a latency, a bandwidth, and information on occupied and free storage blocks on the storage medium M1 to M3. All information about the allocated storage medium M1 to M3 is forwarded to the file system FS1 by the storage control module SSM1 to SSM3. The storage system has a so-called object cache, in which data objects DO are buffered. Provided in the file system FS1 for each of the storage media M1 to M3 is an allocation card (allocation map) AM1 to AM3, wherein is recorded which blocks of the storage medium M1 to M3 are allocated for each data object stored on at least one of the storage media M1 to M3. Provided above the file system FS1 is a virtual file system VFS, which manages multiple file systems FS1 to FS4, maps them into a common storage system, and permits access thereto by user applications UA.

Communication with the user or the user application UA takes place through an interface in the virtual file system VFS. By this means, in addition to the basic functionality of a storage system, additional functionality such as metadata access, access control, or storage media management are made available. In addition to this interface, the primary task of the virtual file system VFS is the combination and management of different file systems FS1 to FS4 into an overall system.

The actual logic of the storage system is hidden in the file system FS1 to FS4. This is where the communication with, and management of, storage control modules SSM1 to SSM3 takes place. The file system FS1 to FS4 manages the object cache, takes care of allocating storage regions to the individual storage media M1 to M3, and takes care of the consistency and security requirements of the data objects.

The storage control modules SSM1 to SSM3 encapsulate the direct communication with the actual storage medium M1 to M3 through different interfaces or network protocols. The primary task in this regard is ensuring communication with the file system FS1 to FS4.

A number of file systems FS1 to FSn, and a number of storage media M1 to Mn, can be provided that differ from the numbers shown in the figure.

The storage system can have the following characteristics:

Internal limits (for 64 bit address space by way of example):
64 bits per file system FS1 to FSn (2⁶⁴ bytes addressable);
2⁶⁴ file systems FS1 to FSn possible at a time (integrated virtual file system VFS);
Maximum of 2⁶⁴ bytes per file; Maximum of 2⁶⁴ files per directory;
Maximum of 2⁶⁴ bytes per (optional) metadata item; Maximum of 2³¹ bytes per object-/file-/directory name;
Unlimited path depth.

Correspondingly different limits can apply for a different address space (for example, 32 bits).

Management of storage media M1 to Mn:
Extent-based allocation strategy within the allocation map;
Different allocation strategies (i.e. delayed allocation) for different requirements;
Copy-on write semantic, automatic versioning; Read-ahead and write-back caching;
Temporary object management for data objects DO that are only kept in volatile working memory;
Storage system can be enlarged and reduced as desired (grow and shrink functionality);
Integrated support of multiple storage media M1 to Mn per host;
Clustering for local multicast or peer-to-peer based networks

Objects/data objects/directories.
One object location (full path) can contain multiple object data streams, i.e.: Directory; File/object; Metadata item; or Block-based integrity;
Transparent compression of individual object data streams with freely selectable and extendible algorithm
Linkage of object locations to one another

General object attributes:
Creation time, last access time, modification time, deletion time;
Object types;
Versions;
Revisions;
Copies;
Access rights and, if applicable, encryption information;
Object data streams: Data stream information; Integrity information; Encryption information; Redundancy information; or Contiguous storage blocks;

Optional metadata for data objects
Extendible data types via plug-in interface
Storage of metadata as independent object stream
Mapping of metadata into subdirectory structures (i.e. “.metadata”)
Plug-in based access to inline metadata (i.e. JPEG, MP3)

Virtual storage system
Simultaneous management of different file systems or different versions via mount points
File system configurations, statistics and monitoring via virtual “.vfs” and “.fs” subdirectory structure

Data protection
Object-based RAID level 0,1,5,6
Object integrity checking: checksum for each structure and each object (i.e. file): SHA1/MD5 or self-implementable via plug-in interface
Management processes for: Online storage system checking; Structure optimization and defragmenting; Dynamic relocation of data objects; Performance monitoring of storage media (changing the write and read speed); or Delete excess versions and copies when space is needed
Block-based integrity checking
Forward error-correction codes (i.e. convolution, Reed-Solomon)
Ensuring of consistency by means including keeping multiple copies of important management data structures
Access protection through user allocations: Expandable using access control lists
Encryption of all structures and data objects: Algorithm selectable per data object; AES or self-implemented algorithm via plug-in interface; or “Secret sharing” and “secret splicing” mode for individual data objects (splitting of information where the individual parts do not permit any inferences to be made concerning the original data objects.)

In addition, the following options can be provided:
Associative storage system: Here, the item of interest is not primarily the names of the individual objects, but instead the metadata associated with the objects. In such storage systems, the user can be provided with a metadata-based view of the data objects in order to simplify finding or categorizing data objects.
Direct storage of graph-based data objects: The data objects can be stored directly, securely and in a versioned manner in the form of graphs (strongly interconnected data).
Offline backup: Revisions of objects in the storage system can be exported to an external storage medium separately from the original object. This offline backup is comparable to known backup strategies, where in contrast to the prior art the inventive method manages the information about the availability and the existence of such backup sets. For example, when an archived data object on a streaming tape is being accessed, the entire associated graph (linked objects) can be read in as a precaution in order to avoid additional time-consuming access to the streaming tape.
Hybrid storage system: Hybrid storage systems carry out a logical and physical separation of storage system management data structures and user data. In this regard, the management data structures can be assigned to very powerful storage media in an optimized manner. In parallel therewith, the user data can be placed on less powerful and progressively less expensive storage media.

FIG. 6 shows a schematic representation of the use of checksums on data streams DS and extents E1 to E3. The integrity of data objects DO is ensured by a two-step process. Step 1: There is a checksum PO of the data objects DO. In this process, a checksum PO for the entire object data stream DS—serialized as a byte data stream—is calculated and stored. Step 2: The object data stream DS itself is divided into checksum blocks PSB1 to PSB3. Each of these checksum blocks PSB1 to PSB3 (which are different from the blocks B of the storage medium) is provided with a checksum PB1 to PB3.

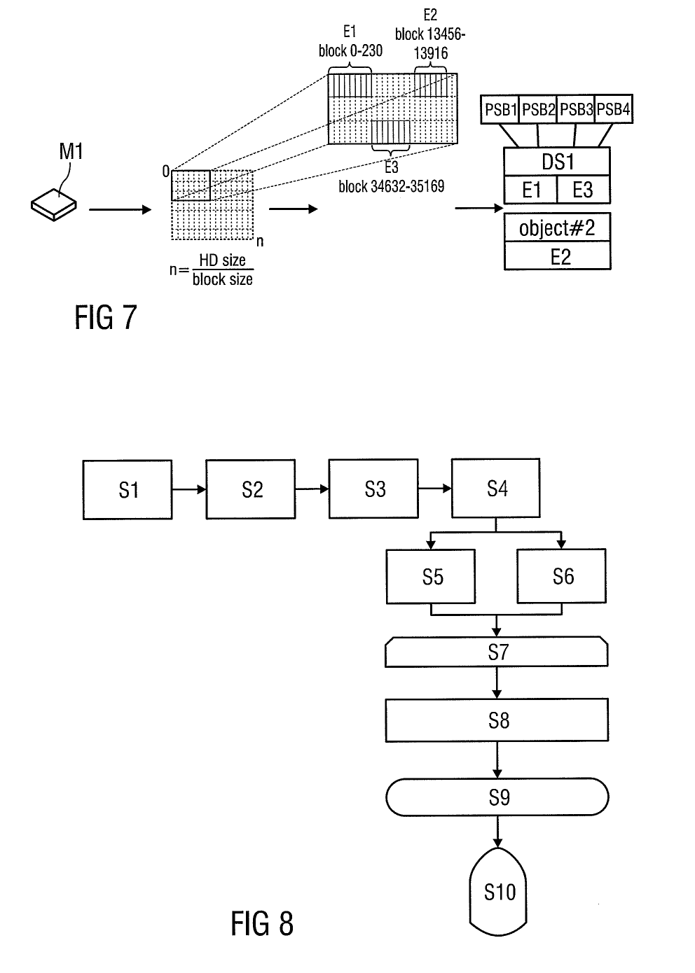

Blocks B of the storage medium M1 to Mn (for example a hard disk) are internally used by the storage medium M1 to Mn as units of organization. Several blocks B form a sector here. The sector size generally cannot be influenced from outside, and results from the physical characteristics of the storage medium M1 to Mn, of the read/write mechanics and electronics, and the internal organization of the storage medium M1 to Mn. Typically, these blocks B are numbered 0 to n, where n corresponds to the number of blocks B. Extents E1 to En combine a block B or multiple blocks B of the storage medium into storage areas. They are not normally protected by an external checksum. Data streams DS are byte data streams that can include one extent E1 to En or multiple extents E1 to En. Each data stream DS is protected by a checksum PO. Each data stream DS is divided into checksum blocks PSB1 to PSBn. Object data streams, directory data streams, file data streams, metadata streams, etc, are special cases of a generic data stream DS and are derived therefrom. Checksum blocks PSB1 to PSBn are blocks of previously defined maximum size for the purpose of producing checksums PB1 to PBn over subregions of a data stream DS. In FIG. 7, the object data stream DS1 is secured by four checksum blocks PSB1 to PSB4, thus also four checksums PB1 to PB4. In addition thereto, the object data stream DS1 also has its own checksum PO over the entire data stream DS1.

FIG. 8 shows a representation of a read access in the storage system, wherein a data object DO is read. First, the reading of the data objects DO is requested through the virtual file system VFS, specifying a path (Step S1). The file system FS1 supplies the position of an inode with the aid of the directory structure (Step S2). An inode is an entry in a file system that contains metadata of a file. The object location points to the inode, which points to the storage space of the object locator (internal data structure, not the same as the object location) or to multiple copies thereof (see also FIG. 8). In a Step S3, the inode belonging to the data object DO is read via the file system FS1, and in a Step S4 the object locator is identified. The identification of a storage layout and the selection of storage IDs as well as the final position and length on the actual storage medium take place in further steps S5, S6, S7. A storage ID designates a unique identification number of a storage medium. This storage ID is used exclusively for the selection and management of storage media. The actual reading of the data objects or partial data are then carried out by the storage control module SSM1 using the identified storage ID (Step S8). In a Step S9, the file system FS1 assembles multiple partial data into a data stream DS1, if necessary, and returns the latter to the virtual file system VFS (Step S10). This is necessary, for example, when the data object is stored so as to be distributed across storage media M1 to Mn (RAID system).

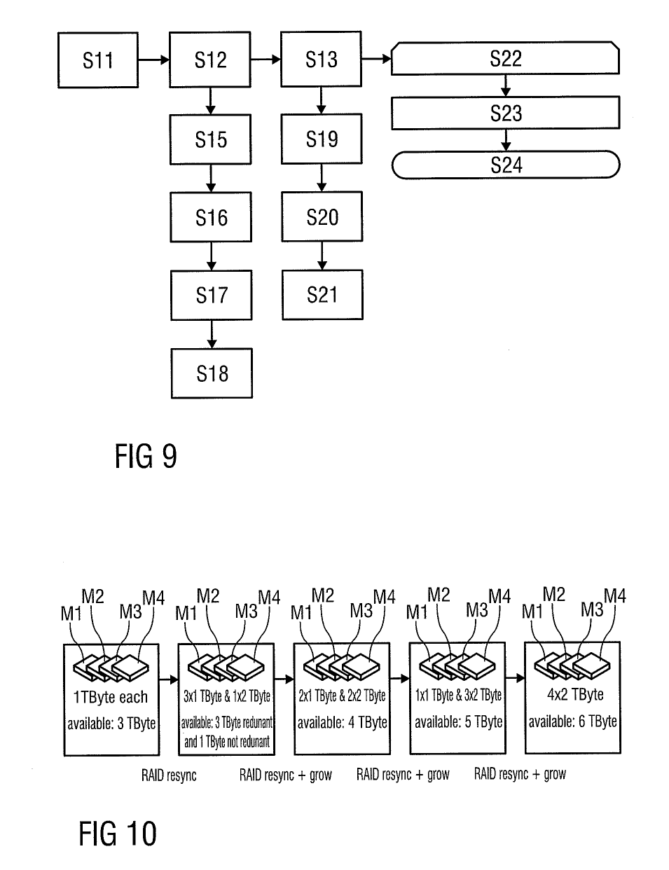

In an analogous manner, FIG. 9 shows a representation of a write access in the storage system, during which a data object DO is written. First, the writing of the data object DO is requested through the virtual file system VFS, specifying a path (Step S11). The file system FS1 creates and allocates an inode (Step S12) and an object locator (Step S13). During creation of the inode, a predefined directory is found and read by the virtual file system VFS (Step S15). In this directory, the position of the inode is entered under the selected name by the file system FS1 (Step S16), the inode is written (Step S17), and the directory (directory object) is written (Step S18). During creation of the object locator, the storage ID is set in a Step S19 by the file system FS1, the object data streams DS1 are allocated (Step S20), and the object locator is written (Step S21). For every object data stream DS1 to DSn to be written, the file system FS1 requests the writing thereof in Step S22. This is then carried out by the storage control module SSM1 in Step S23, whereupon in Step S24 the completion of the write access is communicated to the virtual file system VFS.

FIG. 10 shows a schematic representation of a resynchronization process on the storage system. In the example selected, the storage system includes four storage media M1 to M4, each of which initially has a size of 1 Tbyte. Due to the redundancy in a RAID system, a total of 3 Tbytes of this is available for data objects. If one of the storage media M1 to M4 is now replaced by a larger storage medium M1 to M4 with twice the size, 2 Tbytes, a resynchronization process is then necessary in order to reestablish the redundancy before the RAID system can be used in the customary manner again. The storage space available for data objects initially remains unchanged in this process for the same redundancy level. The additional terabyte is only available without redundancy at first. As soon as another of the storage media M1 to M4 is replaced by one with 2 Tbytes, 4 Tbytes are available for redundant storage after the resynchronization; this accordingly becomes 5 Tbytes when a third of the storage media M1 to M4 is replaced, and 6 Tbyte when the fourth of the storage media is replaced. The resynchronization is required after each replacement. No unnecessary data objects need be moved or copied in this process, since the inventive storage system has the information as to which data blocks are occupied with data objects and which ones are free. Thus, only the useful data needs to be synchronized, and not all allocated and unallocated blocks of the storage media M1 to M4. Accordingly, the resynchronization can be carried out more rapidly. The redundancy levels (RAID levels) in the inventive storage system are not rigidly fixed. Instead, it is only specified what redundancy levels must be maintained as a minimum. During resynchronization, it is possible to change the RAID levels and decide from data object to data object on which storage media M1 to M4 the data object will be stored and with what redundancy.

Information on each of the data objects DO can be maintained in the file system FS1 to FSn, including at least its identifier, its position in a directory tree, and metadata containing at least an allocation of the data object DO, which is to say its storage location on at least one of the storage media M1 to Mn.

The allocation of each of the data objects DO can be chosen by the file system FS1 to FSn with the aid of information on the storage medium M1 to Mn and with the aid of predefined requirements for latency, bandwidth and frequency of access for this data object DO.

Similarly, a redundancy of each of the data objects DO can be chosen by the file system FS1 to FSn with the aid of a predefined minimum requirement with regard to redundancy.

A storage location of the data object DO can be distributed across at least two of the storage media M1 to Mn.

As additional information about the storage medium M1 to Mn, a measure of speed can be determined, which reflects how rapidly previous accesses have taken place.

The allocation of the data objects DO can be extent-based.

A hard disk, a part of a working memory, a tape drive or a remote storage medium through a network can be used as a storage medium M1 to Mn. In this context, information about the storage medium M1 to Mn, at a minimum whether the storage medium is volatile or non-volatile, is passed on.

A strategy of the read or write operation, in particular the read-ahead and write-back caching strategy, can be chosen on the basis of the information on the storage medium M1 to Mn.

Provision can be made to compress the data objects DO for writing and to decompress them after reading in order to save storage space. The compression/decompression can take place transparently.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for management of data objects on at least one storage medium, the method comprising:
allocating a storage control module to each of the storage media;
providing a file system configured to communicate with each of the storage control modules;
obtaining, via the storage control module, information about the storage medium, the information including a latency, a bandwidth, and/or information regarding occupied and free storage blocks on the storage medium; and
forwarding the information related to the allocated storage medium to the file system by the storage control module.

2. The method according to claim 1, wherein information about each of the data objects is maintained in the file system, including at least its identifier, its position in a directory tree, and metadata containing at least an allocation of the data object to at least one of the storage media.

3. The method according to claim 1, wherein the allocation of each of the data objects is selectable by the file system based on the information about the storage medium and based on predefined requirements for latency, bandwidth and frequency of access for the data object.

4. The method according to claim 1, wherein a redundancy of each of the data objects is selected by the file system based on a predefined minimum requirement for redundancy.

5. The method according to claim 2, wherein a storage location of the data object is distributed across at least two of the storage media via the allocation.

6. The method according to claim 1, wherein, as information about the storage medium, a measure of speed is determined, which reflects how rapidly previous accesses have taken place.

7. The method according to claim 1, wherein the allocation of the data objects is extent-based.

8. The method according claim 1, wherein the data object is not copied until it is to be changed.

9. The method according to claim 1, wherein a hard disk, a flash memory, a portion of a working memory, a tape drive, or a remote storage medium through a network is used as the storage medium, and wherein the information about the storage medium that is passed on includes whether the storage medium is volatile or nonvolatile.

10. The method according to claim 1, wherein, during a read operation on the storage medium, an amount of data larger than that requested is sequentially read in and buffered in a volatile memory.

11. The method according to claim 1, wherein, during intended write operations on the storage medium, data objects from multiple write operations are initially buffered in a volatile memory and are then sequentially written to the storage medium.

12. The method according to claim 10, wherein a strategy for the read or write operation is selected on the basis of the information about the storage medium.

13. The method according to claim 1, wherein, in order to ensure integrity of the data object, a data stream, which contains the data object, is protected by a checksum.

14. The method according to claim 13, wherein the data stream is subdivided into checksum blocks, each of which is protected by an additional checksum.

15. The method according to claim 1, wherein the data objects are compressed for writing and decompressed after reading.

16. The method according to claim 1, wherein multiple data objects and/or paths are organized in a manner of a graph and placed in relation to one another.

17. The method according to claim 1, wherein an interface for user applications is provided, via which functionalities related to the data object are extendable.

18. The method according to claim 17, wherein the metadata are made available at the interface by the user application.

19. The method according to claim 17, wherein the user interface is provided for a compression and/ or encryption application selected and/or implemented by the user.

20. The method according to claim 1, wherein a virtual and/or recursive file system is provided in which multiple file systems are incorporated.

21. The method according to claim 2, wherein at least one of the attributes of creation time, last access time, modification time, deletion time, object type, version, revision, copy, access rights, encryption information, or membership in an object data stream is associated with the data object as information.

22. The method according to claim 21, wherein at least one of the attributes of integrity, encryption, or allocated extents is associated with the object data stream as information.

23. The method according to claim 5, wherein, during replacement of one of the storage media, a resynchronization is performed in which the storage location and the redundancy for each data object is newly determined based on the minimum requirements predefined for the data object.

24. A data objects management system for management of data objects on at least one storage medium, the system comprising:
a storage control module configured to be allocated to each of the storage media, the storage control module including information related to the storage medium, the information including a latency, a bandwidth, and/or information regarding occupied and free storage blocks on the storage medium; and
a file system configured to communicate with each of the storage control modules;
wherein the information related to the allocated storage medium is forwarded to the file system by the storage control module.
